(19) United States
(12) Patent Application Publication
(10) Pub. No.: US 2022/0304412 A1
(43) Pub. Date: Sep. 29, 2022

(54) TEAROFF TAB TENSIONER

(71) Applicant: Racing Optics, Inc., Las Vegas, NV (US)

(72) Inventor: Bart E. Wilson, Las Vegas, NV (US)

(21) Appl. No.: 17/210,241

(22) Filed: Mar. 23, 2021

(51) Int. Cl. A42B 3/18; G02B 27/00

(52) U.S. Cl. CPC A42B 3/185; G02B 27/0006

(57) ABSTRACT

A tearoff film lens cover system includes a goggle lens or visor and a pin arranged to receive respective tabs of a plurality of tearoff films positioned on the goggle lens or visor, the pin having a head and a shaft that is narrower than the head. The pin may be disposed on an outrigger of a goggle frame, on a strap clip removably clipped to a goggle strap, or on a racing helmet visor, for example. A resilient body is disposed adjacent the shaft of the pin so as to compress as the tabs of the tearoff films are received by the pin, the resilient body biasing the received tearoff films toward the head of the pin.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

For participants in off-road sports like motocross racing, it is important to maintain visibility of the course as mud, bugs, and other debris accumulate on one's goggles or helmet visor. To this end, tearoff films are commonly employed, either individually or in laminated stacks, which are applied to the goggle lens or visor. As debris accumulates on the outermost tearoff film, the driver simply tears it off to reveal the next pristine film underneath.

With advances in manufacturing technology increasing the optical quality of tearoff films, it has become possible to stack larger and larger numbers of films on the goggle lens or visor without impairing visibility through the multiple layers. This is potentially of great value to drivers for at least two reasons. First, a large number of tearoff films allows the driver to ride for a longer period of time before having to stop to replace the stack. And second, even for shorter rides, the stack of tearoff films can remain installed between rides, reducing the frequency with which the rider has to engage in the time-consuming process of replacing the stack.

Unfortunately, due to safety concerns, goggle and helmet manufacturers typically limit the length of the pin (also called a post) that is used for installing the tearoff films. As a result, the number of tearoff films that can fit on the pin is limited, especially considering the common practice of folding the pull-tab of each tearoff film over itself as it is placed onto the pin (thus doubling the effective thickness of the stack). Moreover, even if a longer pin were used despite the danger of snagging it on something or poking someone, the resulting stack of films would not be easy for the rider to use effectively. The increased length of the pin that would need to be traversed by each pull-tab would force the driver to exert additional effort when removing each film, particularly toward the bottom of the stack. Such additional challenge would impair the driver's ability to concentrate on the course.

### BRIEF SUMMARY

The present disclosure contemplates various goggles, racing helmets, and systems for overcoming the above drawbacks accompanying the related art. One aspect of the embodiments of the disclosure is a tearoff film lens cover system. The tearoff film lens cover system may comprise a goggle lens or visor and a pin arranged to receive respective tabs of a plurality of tearoff films positioned on the goggle lens or visor, the pin having a head and a shaft that is narrower than the head. The tearoff film lens cover system may comprise a resilient body disposed adjacent the shaft of the pin so as to compress as the tabs of the tearoff films are received by the pin, the resilient body biasing the received tearoff films toward the head of the pin.

The pin may be greater than 6 mm long. The pin may be 10-12 mm long.

The resilient body may be disposed to at least partially surround the shaft of the pin. The resilient body may preferably comprise an open cell foam, but other resilient natural or polymer resilient materials are contemplated. The resilient foam body may have a firmness of 0.4-0.8 PSI, preferably 0.5-0.7 PSI (e.g., 0.6 PSI), denoting an amount of force required to compress the resilient foam body by 25%. The tearoff film lens cover system may comprise a protective surface covering a resilient foam member. The resilient foam body may comprise a self-skinning foam, and the protective surface may be a surface skin thereof.

The tearoff film lens cover system may comprise the plurality of tearoff films. The plurality of tearoff films may be positioned on the goggle lens or visor with the respective tabs received by the pin. The plurality of tearoff films may include more than twenty-eight tearoff films. A lowermost tearoff film of the plurality of tearoff films may be adhered to the goggle lens or visor by an adhesive. The adhesive may be formed as a band at a periphery of the lowermost tearoff film or as a film extending partially or completely upon the lowermost tearoff.

Another aspect of the embodiments of the disclosure is goggles. The goggles may comprise a goggle lens and a pin arranged to receive respective tabs of a plurality of tearoff films positioned on the goggle lens, the pin having a head and a shaft that is narrower than the head. The goggles may comprise a resilient body disposed adjacent the shaft of the pin so as to compress as the tabs of the tearoff films are received by the pin, the resilient body biasing the received tearoff films toward the head of the pin.

The goggles may comprise a frame that supports the goggle lens, the pin being disposed on an outrigger of the frame. The goggles may comprise a strap for fixing the goggle lens to a wearer's head and a strap clip removably clipped to the strap, the pin being disposed on the strap clip. The goggle lens may be devoid of pins for receiving the plurality of tearoff films.

Another aspect of the embodiments of the disclosure is a goggle lens system comprising the above goggles and the plurality of tearoff films. The plurality of tearoff films may be positioned on the goggle lens with the respective tabs received by the pin. A lowermost tearoff film of the plurality of tearoff films may be adhered to the goggle lens by an adhesive.

Another aspect of the embodiments of the disclosure is a racing helmet. The racing helmet may comprise a visor and a pin arranged to receive respective tabs of a plurality of tearoff films positioned on the visor, the pin having a head and a shaft that is narrower than the head. The racing helmet may comprise a resilient body disposed adjacent the shaft of the pin so as to compress as the tabs of the tearoff films are received by the pin, the resilient body biasing the received tearoff films toward the head of the pin.

The pin may be removably attached to the visor.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a tearoff film lens cover system according to the present disclosure, implemented in a pair of goggles;

FIG. 2 is a top view thereof;

FIG. 3 is an exploded front view thereof;

FIG. 4 is a front view thereof with the tearoff films removed;

FIG. 5 is a side view thereof showing a pin of the tearoff film lens cover system, the pin being disposed on an outrigger of a goggle frame;

FIG. 6 is a front view of the tearoff film lens cover system implemented in a different pair of goggles with the pin disposed on a strap clip; and

FIG. 7 shows a front view of the tearoff film lens cover system implemented in a racing helmet.

### DETAILED DESCRIPTION

The present disclosure encompasses various embodiments of goggles, racing helmets, and systems for accommodating tearoff films for use in off-road sports such as motocross. The detailed description set forth below in connection with the appended drawings is intended as a description of several currently contemplated embodiments and is not intended to represent the only form in which the disclosed innovations may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

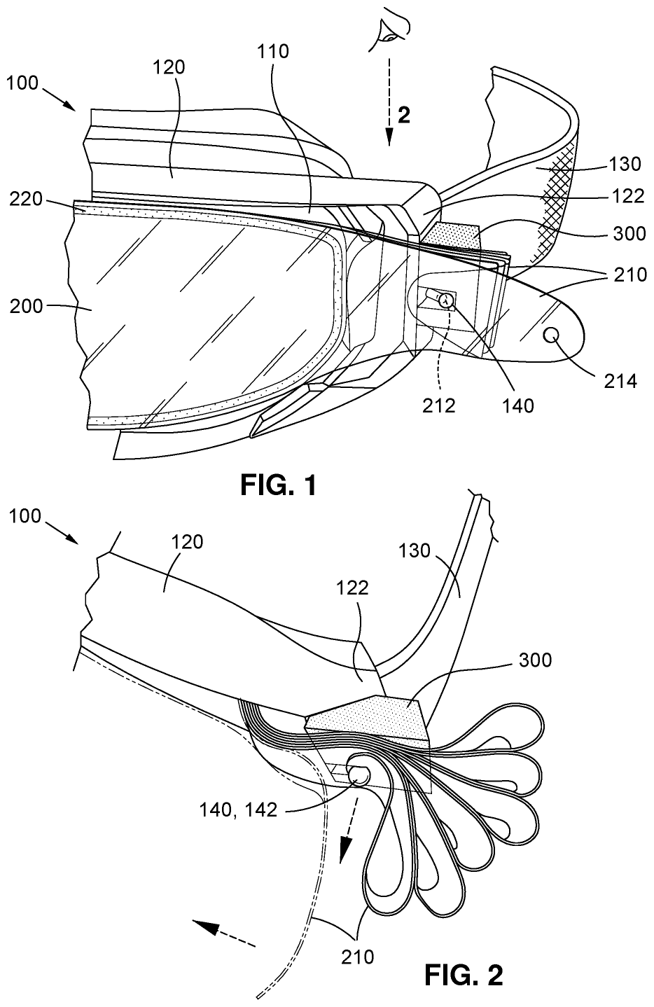

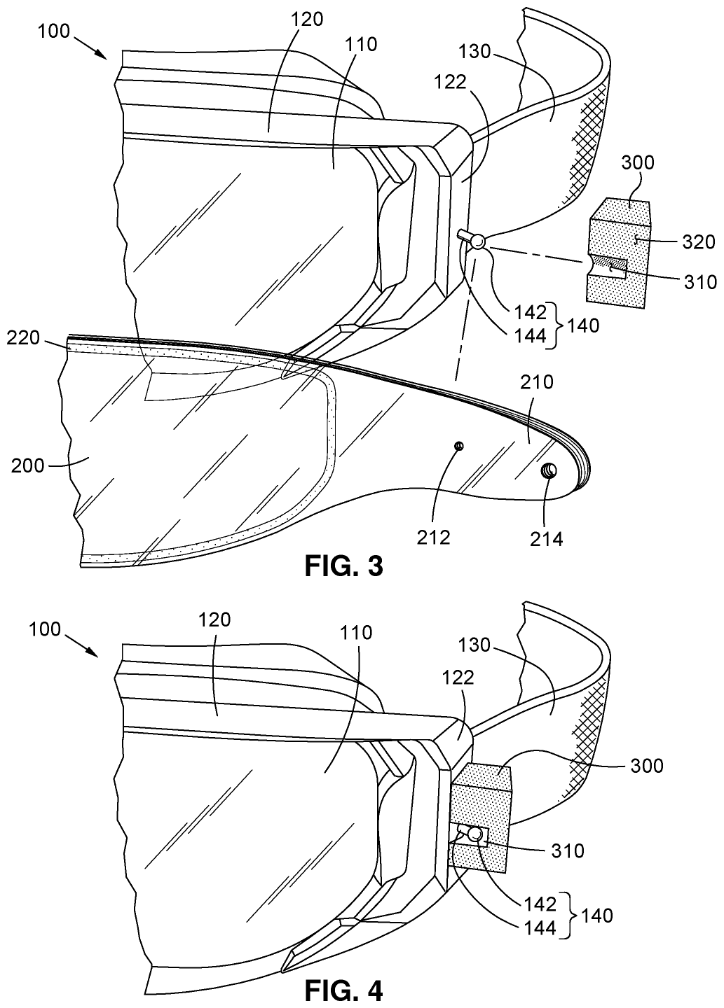

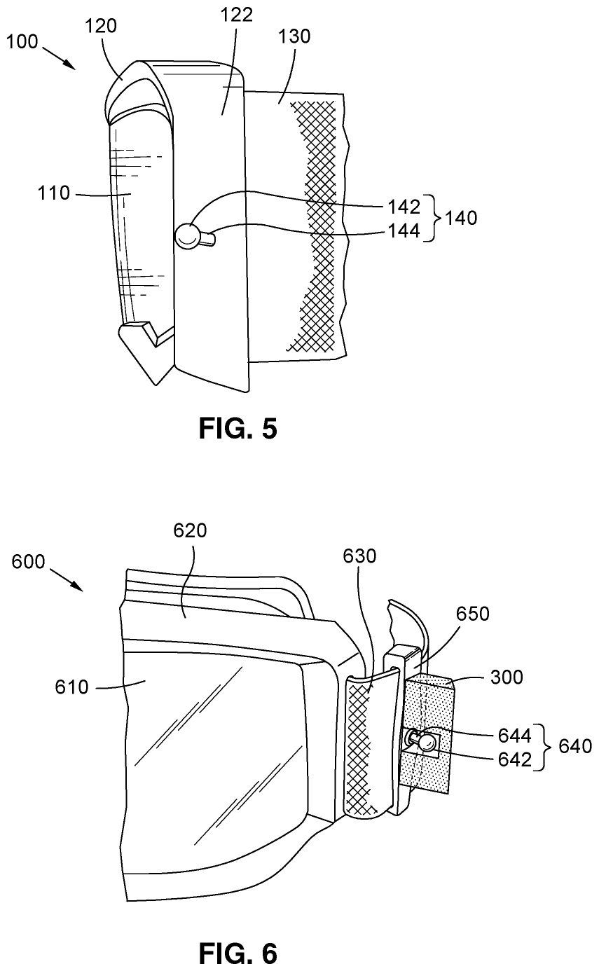

FIG. 1 is a front view of a tearoff film lens cover system according to an embodiment of the present disclosure. FIGS. 2-5 are additional views thereof. In the example of FIGS. 1-5, the tearoff film lens cover system is implemented in a pair of goggles 100 having a goggle lens 110, a frame 120 that supports the goggle lens 110, and a strap 130 connected to the frame 120 for fixing the goggle lens 110 to the wearer's head. In the exemplary goggles 100, a pin 140 is disposed on an outrigger 122 of the frame 120, the pin 140 having a head 142 and a shaft 144 that is narrower than the head 142 (see FIGS. 3-5). The pin 140 may be arranged to receive respective tabs 210 of a plurality, i.e., stack, of tearoff films 200 positioned on the goggle lens 110. The stack of tearoff films is well known in the art and is disclosed in U.S. Pat. No. 6,388,813 entitled OPTICAL STACK OF LAMINATED REMOVABLE LENSES FOR FACE SHIELDS WINDOWS AND DISPLAYS, the entire content of which is expressly incorporated herein by reference. To this end, the pin 140 may typically be disposed on the left-hand outrigger 122 in order to provide easy left-hand access for a wearer of the goggles 100 to pull the tabs 210 while riding or driving a motorcycle, bike or other vehicle, without having to remove his or her right hand from the throttle of the vehicle.

As the tab 210 of a tearoff film 200 is pushed down onto the pin 140, the head 142 and shaft 144 of the pin 140 may pass through a first hole 212 in the tab 210 (shown in phantom in FIG. 1, visible in FIG. 3). In order for the head 142 of the pin 140 to pass through the first hole 212, it may be necessary for the first hole 212 to moderately stretch, which may be accomplished by using a flexible material for the tearoff film 200, for example. That is, the first hole 212 may be sized so that the head 142 of the pin 140 prevents the tearoff film 200 from easily falling off the pin 140 once the head 142 has passed through the first hole 212. The tabs 210 of a plurality of tearoff films 200 may be received by the pin 140, one after another, with the received tabs 210 forming a stack on the shaft 144 of the pin 140. In practice, the tab 210 of each tearoff film 200 may additionally be provided with a second hole 214 closer to the end of the tab 210 (i.e. farther from the goggle lens 110) that is larger than the first hole 212 and easily fits over the head 142 of the pin 140. As the tabs 210 are stacked on the pin 140, each tab 210 may be folded back on itself and the larger second hole 214 placed over the pin 140 and manually held down until the first hole 212 of the next tab 210 is received by the pin 140 on top of it. In this way, the plurality of stacked tabs 210 may form loops as shown in FIGS. 1 and 2, with the topmost tab 210 remaining unfolded (as the second hole 214 is too large to be held onto the stack by the head 142 of the pin 140). By forming the stack of tabs 210 in this way, the topmost tab 210 juts out to the side of the goggles 100 farther than the others, making it easier for the wearer to grab only the topmost tab 210 with his or her hand to pull the topmost tearoff film 200 off the goggles 100 while operating the vehicle. As each tearoff film 200 is pulled off, the second hole 214 of the next topmost tab 210 is no longer held onto the pin 140 by anything and comes off, causing the tab 210 to unfold and spring out to its full length, held onto the pin 140 only by its smaller first hole 212. In this way, the topmost tab 210 again juts out farther than the others, making it easy to grab. FIG. 2 illustrates the moment when the topmost tab 210 (shown in phantom) has been pulled off the pin 140, causing the next tab 210 to unfold as illustrated by the arrows.

In order to allow for a large stack, i.e., a large number, of tearoff films 200 to be used with the goggles 100, a resilient body 300 may be disposed adjacent the shaft 144 of the pin 140 so as to compress as the tabs 210 of the tearoff films 200 are received by the pin 140. The resilient body 300 may be adhered to the outrigger 122 of the frame 120 by an adhesive, for example. In the illustrated example, as best seen in FIGS. 1 and 4, the resilient body 300 is disposed so as to at least partially surround the shaft 144 of the pin 140. For example, the resilient body 300 may define a notch 310 that fits around the shaft 144 of the pin 140 (see FIGS. 3 and 4). As an alternative to the notch 310, it is contemplated that the resilient body may define a centrally located through hole through which the pin 140 extends. Due to its resilient nature, the resilient body 300 acts as a spring to bias the stack of tabs 210 of the tearoff films 200 that are on the pin 140 toward the head 142 of the pin 140. In this way, the stack of tabs 210 is always urged outwardly toward the top of the shaft 144, with the topmost tab 210 at the very top of the shaft 144 just below the head 142 of the pin 140. As a result, it is never necessary for the entire length of the pin 140 to be traversed in order for a tearoff film 200 to be removed, even when there are only a few tearoff films 200 remaining in the stack. At the same time, because the resilient body 300 and stack of tabs 210 remain at the head 142 of the pin 140, there is no significant protruding portion of the pin 140 that might otherwise present a hazard. The pin 140 can thus be made longer than it is in the case of conventional goggles and may be greater than 6 mm long (inclusive of a 2 mm head 142), for example, such as 10-12 mm long, allowing a much larger stack of tearoff films 200 to be safely applied to the goggles 100.

By using a resilient body 300 as the biasing member, a consistent and repeatable spring force can be applied to the stack of tabs 210 without requiring any moving parts or mechanical springs. Although natural and polymer resilient bodies are contemplated herein, a preferred resilient body is a resilient foam body. In general, a variety of foams may be used including open and closed cell foams made from neoprene, silicone, polyethylene, a fluoroelastomer material such as Viton, ethylene propylene diene monomer (EPDM), ethylene-vinyl acetate (EVA), vinyl, polyurethane, and polyimide, with firmness ranging up to 60 PSI (denoting an amount of force required to compress the foam by 25%). For purposes of providing the necessary tension to bias the tabs 210 of the tearoff films 200 toward the head 142 of the pin 140 without forcing the tabs 210 off the head 142 of the pin 140, the resilient foam body 300 may preferably be an open cell foam such as a very soft polyurethane foam. In general, the peel strength to remove a tearoff film 200 may be between 15 and 75 grams according to the American Society for Testing and Materials (ASTM) D3330 standard, while the pull strength to remove a tab 210 from the pin 140 (i.e., to pull the first hole 212 off the head 142 of the pin 140) may be between 10 and 50 grams. The necessary tension to appropriately bias the tearoff films 200 without prematurely ejecting them from the pin 140 may be achieved with a resilient foam body 300 having a firmness of 0.4-0.8 PSI, preferably 0.5-0.7 PSI (e.g. 0.6 PSI), denoting an amount of force required to compress the resilient foam body 300 by 25%.

The resilient foam member 300 may be formed in differing shapes including, but not limited to, a wedge-shape or shaped as a rectangular prism, for example, with the exact shape depending on design considerations such as the angle of the surface of the outrigger 122 relative to the angle at which the pin 140 protrudes. A protective surface 320 may cover the resilient foam member 300 to protect the resilient foam member 300 from chafing and becoming worn or damaged as mud and other debris impacts the resilient foam member 300 during use. The protective surface 320 may also serve to allow for a uniform spring load as the tabs 210 of the tearoff films 200 are loaded onto the pin 140. The protective surface 320 may be a smooth plastic such as an injection moldable polypropylene, low density polypropylene (LDPE), or polystyrene. In some cases, the resilient foam member 300 may be made of a self-skinning foam, in which case the protective surface 320 may be a high-density surface skin of the resilient foam member 300.

Owing to the biasing effect of the resilient foam member 300 and the increased length of the pin 140 that is possible as a result, a much larger stack of tearoff films 200 may be safely and conveniently used with the goggles 100. Assuming a film thickness of 2 mil (0.0508 mm) and a single fold of each tab, resulting in an effective thickness of 4 mil (0.1016 mm), a typical pair of goggles may be able to hold at most twenty-one or twenty-eight tearoff films. In contrast, the disclosed goggles 100 having the resilient foam member 300 may allow for more than twenty-eight tearoff films 200 (e.g., more than four laminated sets of seven films each) to be installed. In some cases, depending on the length of the pin 140, there may be as many as thirty-five, forty, or even fifty tearoff films 200 as may sometimes be needed in a single endeavor, such as a motocross race.

FIG. 6 is a front view of the tearoff film lens cover system implemented in a different pair of goggles 600 with a pin 640 for receiving the tabs 210 of the tearoff films 200 being disposed on a strap clip 650. The goggles 600 may have a goggle lens 610, frame 620, strap 630, and pin 640 that are the same as or functionally the same as the goggle lens 110, frame 120, strap 130, and pin 140 of the exemplary goggles 100 shown in FIGS. 1-5, except for the following difference. Whereas the pin 140 of the goggles 100 is disposed on an outrigger 122 of the frame 120, the pin 640 of the goggles 600 shown in FIG. 6 may be disposed on a strap clip 650. In all other respects, the pin 640 may be the same as the pin 140 and may have a head 642 and shaft 644 that have the same dimensions as the head 142 and shaft 144 of the pin 140. The strap clip 650 may be made of plastic, for example, and may engage with the strap 630 at a position along the strap 630 of the wearer's choosing. Since the strap 630 curves around the wearer's head while the goggles 600 are being worn, the position and angle of the pin 640 may be partly determined by the position of the strap clip 650. Therefore, by adjusting the position of the strap lip 650, the wearer of the goggles 600 may adjust the position and angle of the tabs 210 according to his or her preference for easy tearing. The resilient foam member 300 may be disposed adjacent the shaft 644 of the pin 640 so as to compress as the tabs 210 of the tearoff films 200 are received by the pin 640. The use of the tearoff films 200 in relation to the pin 640 may be identical to the use of the tearoff films 200 with the pin 140 (see, e.g., FIGS. 1-3), and thus the stack of tearoff films 200 is not separately illustrated here.

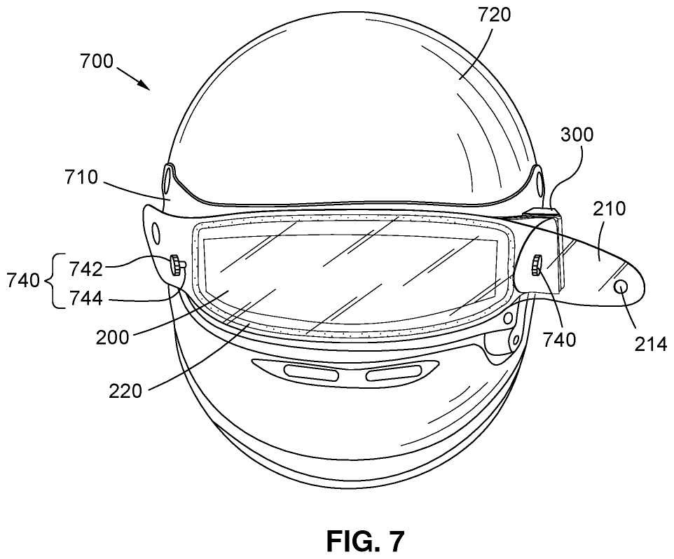

FIG. 7 shows a front view of the tearoff film lens cover system implemented in a racing helmet 700. The racing helmet 700 may have a visor 710 that attaches to a shell 720 designed to protect the wearer's head. Similar to the above examples of the goggles 100, 600, the racing helmet 700 may have a pin 740 (also called a post) arranged to receive respective tabs 210 of a plurality of tearoff films 200 positioned on the visor 710, the pin 740 having a head 742 and a shaft 744 that is narrower than the head 742. In the illustrated example, respective pins 740 are provided on either side of the visor 710 outside a viewing portion of the visor 710 (e.g., on a portion of the visor 710 that abuts an outer surface of the shell 720). To prepare the racing helmet 700 for installation of a stack of tearoff lenses 200, each pin 740 may be removably attached to the visor 710, for example, by inserting it through a dedicated opening in the visor 710 where it may connect to a corresponding backing piece on the other side of the visor 710. As in the case of the goggles 100, 600, a resilient body 300 may be disposed on one side adjacent the shaft 744 of the pin 742 so as to compress as the tabs 210 of the tearoff films 200 are received by the pin 740, the resilient body biasing the received tearoff films 200 toward the head 742 of the pin 740. In the case of the racing helmet 700 shown in FIG. 7, the resilient body 300 may be adhered to the visor 710, for example, rather than to an outrigger 122 or strap clip 650 as in the above examples. In all other respects, the resilient body 300 may function in the same way in relation to the pin 740 as described above in relation to the pin 140, 640.

As shown in FIGS. 1, 3, and 7, a lowermost tearoff film 200 of the plurality of tearoff films 100 may be adhered to the goggle lens 110, 610, or visor 710 by an adhesive 220. The adhesive 220 may preferably be formed as a band at a periphery of the lowermost tearoff film 200 as shown and may have a pull strength greater than the pull strength between adjacent films of the stack in order to avoid premature removal of the stack. Examples of such an adhesive 220 may be found in U.S. Pat. No. 6,536,045, entitled TEAR-OFF OPTICAL STACK HAVING PERIPHERAL SEAL MOUNT, the entire content of which is expressly incorporated herein by reference. Alternatively, the adhesive 220 may be a pressure sensitive adhesive or preferably a dry mount self wetting adhesive, an example of which may be found in U.S. Pat. No. 9,295,297, entitled ADHESIVE MOUNTABLE STACK OF REMOVABLE LAYERS, the entire content of which is expressly incorporated herein by reference. Owing to the use of the adhesive 220, the goggle lens 110, 610 itself may be devoid of conventional prior art pins for receiving the plurality of tearoff films 200 and holding them in place, as this function may instead be performed by the adhesive 220. Because it is unnecessary to form additional pins in the goggle lens 110, 610 for the purpose of holding the tearoff films 200 in place, the impact resistance of the goggle lens 110, 610 can be greatly improved, making it much easier to pass high-impact requirements such as those of American National Standards Institute (ANSI) Z87.1. By the same token, it is unnecessary to form openings in the tearoff films 200 corresponding to such unneeded lens pins. In the case of the racing helmet 700, it is typical for a stack of tearoff films 200 to be held onto the visor 710 by the tabs 210 alone, with the pins 740 being provided as a pair for this purpose. By using the adhesive 220, it may be assured that the stack of tearoff films 200 is pressed flush against the visor 710 for better optical performance. It is also contemplated that one of the two pins 740 may be omitted since the function of holding the tearoff films 200 against the visor 710 may be performed by the adhesive 220.

The above description is given by way of example, and not limitation. Given the above disclosure, one skilled in the art could devise variations that are within the scope and spirit of the innovations disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A tearoff film lens cover system comprising:
a goggle lens or visor;
a pin arranged to receive respective tabs of a plurality of tearoff films positioned on the goggle lens or visor, the pin having a head and a shaft that is narrower than the head; and
a resilient body disposed adjacent the shaft of the pin so as to compress as the tabs of the tearoff films are received by the pin, the resilient body biasing the received tearoff films toward the head of the pin.

2. The tearoff film lens cover system of claim 1, wherein the pin is greater than 6 mm long.

3. The tearoff film lens cover system of claim 2, wherein the pin is 10-12 mm long.

4. The tearoff film lens cover system of claim 1, wherein the resilient body is disposed to at least partially surround the shaft of the pin.

5. The tearoff film lens cover system of claim 1, wherein the resilient body comprises an open cell foam body.

6. The tearoff film lens cover system of claim 1, wherein the resilient foam body has a firmness of 0.4-0.8 PSI denoting an amount of force required to compress the resilient foam body by 25%.

7. The tearoff film lens cover system of claim 6, wherein the resilient foam body has a firmness of 0.5-0.7 PSI denoting an amount of force required to compress the resilient foam body by 25%.

8. The tearoff film lens cover system of claim 1, further comprising a protective surface covering the resilient foam body.

9. The tearoff film lens cover system of claim 8, wherein the resilient foam body comprises a self-skinning foam, and the protective surface is a surface skin thereof.

10. The tearoff film lens cover system of claim 1, further comprising the plurality of tearoff films, wherein the plurality of tearoff films are positioned on the goggle lens or visor with the respective tabs received by the pin.

11. The tearoff film lens cover system of claim 10, wherein the plurality of tearoff films includes more than twenty-eight tearoff films.

12. The tearoff film lens cover system of claim 10, wherein a lowermost tearoff film of the plurality of tearoff films is adhered to the goggle lens or visor by an adhesive.

13. The tearoff film lens cover system of claim 12, wherein the adhesive is formed as a band at a periphery of the lowermost tearoff film.

14. Goggles comprising:
a goggle lens;
a pin arranged to receive respective tabs of a plurality of tearoff films positioned on the goggle lens, the pin having a head and a shaft that is narrower than the head; and
a resilient body disposed adjacent the shaft of the pin so as to compress as the tabs of the tearoff films are received by the pin, the resilient body biasing the tabs of the received tearoff films toward the head of the pin.

15. The goggles of claim 14, further comprising a frame that supports the goggle lens, the pin being disposed on an outrigger of the frame.

16. The goggles of claim 14, further comprising a strap for fixing the goggle lens to a wearer's head and a strap clip removably clipped to the strap, the pin being disposed on the strap clip.

17. The goggles of claim 14, wherein the goggle lens is devoid of pins for receiving the plurality of tearoff films.

18. A goggle lens system comprising:
the goggles of claim 17; and
the plurality of tearoff films, wherein the plurality of tearoff films are positioned on the goggle lens with the respective tabs received by the pin, a lowermost tearoff film of the plurality of tearoff films being adhered to the goggle lens by an adhesive.

19. A racing helmet comprising:
a visor;
a pin arranged to receive respective tabs of a plurality of tearoff films positioned on the visor, the pin having a head and a shaft that is narrower than the head; and
a resilient body disposed adjacent the shaft of the pin so as to compress as the tabs of the tearoff films are received by the pin, the resilient body biasing the received tearoff films toward the head of the pin.

20. The racing helmet of claim 19, wherein the pin is removably attached to the visor.
